(19) United States
(12) Patent Application Publication
(10) Pub. No.: US 2025/0215141 A1
(43) Pub. Date: Jul. 3, 2025

(54) POLYURETHANE RESIN AND METHOD FOR PRODUCING THE SAME

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); CHENG-LI CHAO, TAIPEI (TW); Hui-Chun Chuang, TAIPEI (TW)

(21) Appl. No.: 18/639,926

(22) Filed: Apr. 18, 2024

(30) Foreign Application Priority Data
Dec. 27, 2023 (TW) 112150985

(51) Int. Cl. C08G 18/48; C08G 18/08; C08G 18/12; C08G 18/32; C08G 18/80

(52) U.S. Cl. CPC C08G 18/4812; C08G 18/0852; C08G 18/12; C08G 18/3206; C08G 18/8077

(57) ABSTRACT

A polyurethane resin and method for producing the same are provided. The method includes a mixing process implemented by mixing a polyether glycol and a polyether triol, a reacting process implemented by adding an isocyanate into the polyether glycol and the polyether triol that are mixed with each other to form a first polymer, a chain extending process implemented by adding a chain extender to the first polymer to form a second polymer, a blocking process implemented by adding a blocking agent to the second polymer to form a third polymer, and a diluting process implemented by diluting the third polymer with a diluting solvent to form a polyurethane resin. The polyurethane resin has a hard chain ratio between 27% and 34%, a glass transition temperature between −40.2° C. and −44.8° C., and a tensile strength between 62.5 kg/3 cm and 68.7 kg/3 cm.

### CROSS-REFERENCE TO RELATED PATENT APPLICATION

This application claims the benefit of priority to Taiwan Patent Application No. 112150985, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyurethane resin and a method for producing the same, and more particularly to a polyurethane resin that is applicable to shoe leather and a method for producing the same.

### BACKGROUND OF THE DISCLOSURE

A conventional polyurethane resin used in shoe leather has an issue of an insufficient strength.

### SUMMARY OF THE DISCLOSURE

In response to the above-referenced technical inadequacy, the present disclosure provides a polyurethane resin and a method for producing the same, so as to effectively improve on an issue of a conventional polyurethane resin used in shoe leather having insufficient strength.

In order to solve the above-mentioned problems, one of the technical aspects adopted by the present disclosure is to provide a method for producing a polyurethane resin. The method for producing the polyurethane resin includes a mixing process, a reacting process, a chain extending process, a blocking process, and a diluting process. The mixing process is implemented by mixing a polyether glycol and a polyether triol. The reacting process is implemented by adding an isocyanate into the polyether glycol and the polyether triol that are mixed with each other to form a first polymer. The chain extending process is implemented by adding a chain extender to the first polymer to form a second polymer. The blocking process is implemented by adding a blocking agent to the second polymer to form a third polymer. The diluting process is implemented by diluting the third polymer with a diluting solvent to form a polyurethane resin. Based on a total weight of the polyurethane resin being 100 wt %, a content of the polyether glycol is between 31.6 wt % and 40.3 wt %, a content of the polyether triol is between 14.5 wt % and 26.3 wt %, and a content of the isocyanate is between 18.3 wt % and 21.8 wt %. The polyether glycol has a number average molecular weight between 2,000 and 3,000, and the polyether triol has a number average molecular weight between 3,000 and 6,000.

In one of the possible or preferred embodiments, the polyurethane resin has a weight average molecular weight between 27,450 and 29,800.

In one of the possible or preferred embodiments, the polyether glycol is polypropylene glycol, and the polyether triol is selected from the group consisting of poly-tetramethylene-ether-glycol and polyglycerol, and the isocyanate is selected from the group consisting of methylenediphenyl diisocyanate, toluene diisocyanate, and isophorone diisocyanate.

In one of the possible or preferred embodiments, the chain extender is selected from the group consisting of an ethylene glycol, 1,4-butanediol, and 1,6-hexanediol, and the blocking agent is selected from the group consisting of methyl ethyl ketoxime and dimethyl-ketoxime.

In one of the possible or preferred embodiments, the diluting solvent is selected from the group consisting of propylene glycol monomethyl ether acetate and propylene glycol methyl ether, and the polyurethane resin has a solid content between 91% and 92%, and the solid content is defined as a weight ratio of a weight of the polyurethane resin after drying divided by a weight of the polyurethane resin before drying.

In one of the possible or preferred embodiments, based on the total weight of the polyurethane resin being 100 wt %, a content of the chain extender is between 4.5 wt % and 6 wt %, a content of the blocking agent is between 7.8 wt % and 9.9 wt %, and a content of the diluting solvent is between 7.9 wt % and 8.1 wt %.

In order to solve the above-mentioned problems, another one of the technical aspects adopted by the present disclosure is to provide a polyurethane resin. The polyurethane resin includes a polyether glycol, a polyether triol, an isocyanate, a chain extender, a blocking agent, and a diluting solvent. Based on a total weight of the polyurethane resin being 100 wt %, a content of the polyether glycol is between 31.6 wt % and 40.3 wt %, a content of the polyether triol is between 14.5 wt % and 26.3 wt %, and a content of the isocyanate is between 18.3 wt % and 21.8 wt %. The polyurethane resin has a hard chain ratio between 27% and 34%, and the hard chain ratio is defined as a ratio of a sum of a content of the isocyanate and a content of the chain extender to an overall content of the polyurethane resin. The polyurethane resin has a glass transition temperature between −40.2° C. and −44.8° C. and a tensile strength between 62.5 kg/3 cm and 68.7 kg/3 cm. The polyether glycol has a number average molecular weight between 2,000 and 3,000. The polyether triol has a number average molecular weight between 3,000 and 6,000.

In one of the possible or preferred embodiments, the polyurethane resin has a weight average molecular weight between 27,450 and 29,800.

In one of the possible or preferred embodiments, the polyether glycol is polypropylene glycol, and the polyether triol is selected from the group consisting of poly-tetramethylene-ether-glycol and polyglycerol, and the isocyanate is selected from the group consisting of methylenediphenyl diisocyanate, toluene diisocyanate, and isophorone diisocyanate.

In one of the possible or preferred embodiments, the chain extender is selected from the group consisting of ethylene glycol, 1,4-butanediol, and 1,6-hexanediol, and the blocking agent is selected from the group consisting of methyl ethyl ketoxime and dimethyl-ketoxime.

In one of the possible or preferred embodiments, the diluting solvent is selected from the group consisting of propylene glycol monomethyl ether acetate and propylene glycol methyl ether, and a solid content of the polyurethane resin is between 91% and 92%, and the solid content is defined as a weight ratio of the polyurethane resin after drying to the polyurethane resin before drying.

In one of the possible or preferred embodiments, based on the total weight of the polyurethane resin being 100 wt %, a content of the chain extender is between 4.5 wt % and 6 wt %, a content of the blocking agent is between 7.8 wt % and 9.9 wt %, and a content of the diluting solvent is between 7.9 wt % and 8.1 wt %.

Therefore, in the polyurethane resin and the method for producing the same provided by the present disclosure, by virtue of “based on a total weight of the polyurethane resin being 100 wt %, a content of the polyether glycol being between 31.6 wt % and 40.3 wt %, a content of the polyether triol being between 14.5 wt % and 26.3 wt %, and a content of the isocyanate being between 18.3 wt % and 21.8 wt %” and “the polyurethane resin having a hard chain ratio between 27% and 34%, a glass transition temperature between −40.2° C. and −44.8° C., and a tensile strength between 62.5 kg/3 cm and 68.7 kg/3 cm,” the issue of existing polyurethane resin used in shoe leather having insufficient strength can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing a polyurethane resin according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Method for Producing a Polyurethane Resin

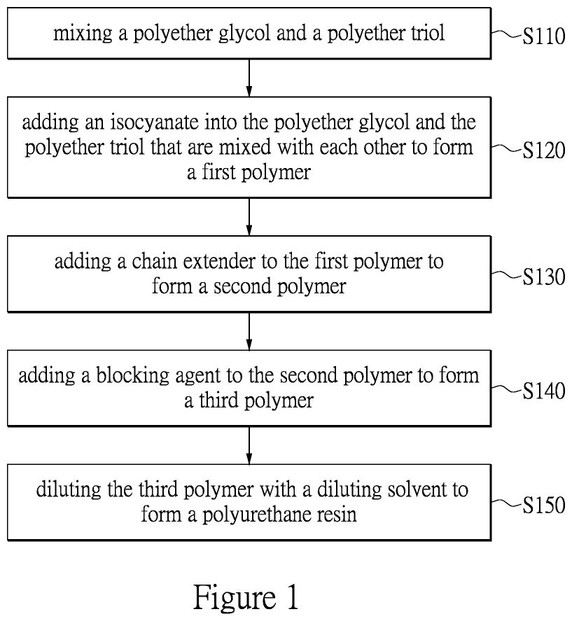

Referring to FIG. 1, FIG. 1 is a flowchart of a method for producing a polyurethane resin according to an embodiment of the present disclosure. An embodiment of the present disclosure provides a method for producing a polyurethane resin. The method for producing a polyurethane resin includes a mixing process S110, a reacting process S120, a chain extending process S130, a blocking process S140, and a diluting process S150.

In the mixing process S110, a polyether glycol and a polyether triol are mixed. The polyether glycol has a number average molecular weight between 2,000 and 3,000, and the polyether triol has a number average molecular weight between 3,000 and 6,000. In one of the embodiments, the polyether glycol is polypropylene glycol, and the polyether triol is selected from the group consisting of poly-tetramethylene-ether-glycol and polyglycerol.

In the reacting process S120, an isocyanate is added into the polyether glycol and the polyether triol that are mixed with each other to form a first polymer. More specifically, in the reacting process S120, a temperature of a reaction tank containing the polyether glycol and the polyether triol can be raised to between about 40° C. and 60° C. (preferably about 50° C.), the isocyanate and a small amount of bismuth carboxylate catalyst are added, and the temperature is raised to between about 60° C. and 80° C. (preferably about 70° C.) for about 1.5 hours. In one of the embodiments, the isocyanate is selected from the group consisting of methylenediphenyl diisocyanate, toluene diisocyanate, and isophorone diisocyanate.

In the chain extending process S130, a chain extender is added to the first polymer to form a second polymer. More specifically, after adding the chain extender and reacting with the first polymer for about 1.5 hours, the temperature is reduced to between 35° C. and 55° C. (preferably about 45° C.). In one of the embodiments, the chain extender is selected from the group consisting of an ethylene glycol, 1,4-butanediol, and 1,6-hexanediol.

In the blocking process S140, a blocking agent is added to the second polymer to form a third polymer. The reacting time of the blocking process S140 can be about 1 hour to ensure that a blocking reaction is completed. In one of the embodiments, the blocking agent is selected from the group consisting of methyl ethyl ketoxime and dimethyl-ketoxime.

In the diluting process S150, the third polymer is diluted with a diluting solvent to form a polyurethane resin. In one embodiment, the diluting solvent is selected from the group consisting of propylene glycol monomethyl ether acetate and propylene glycol methyl ether, the polyurethane resin has a solid content between 91% and 92%, and the solid content is defined as a weight ratio of a weight of the polyurethane resin after drying divided by a weight of the polyurethane resin before drying. If the method does not include the diluting process S150, the finally produced polyurethane resin will have an excessive viscosity and difficulties during processing.

Based on a total weight of the polyurethane resin being 100 wt %, a content of the polyether glycol is between 31.6 wt % and 40.3 wt %, a content of the polyether triol is between 14.5 wt % and 26.3 wt %, a content of the isocyanate is between 18.3 wt % and 21.8 wt %, a content of the chain extender is between 4.5 wt % and 6 wt %, a content of the blocking agent is between 7.8 wt % and 9.9 wt %, and a content of the diluting solvent is between 7.9 wt % and 8.1 wt %.

It is worth mentioning that, in the polyurethane resin, the content of the polyether glycol is greater than the content of the polyether triol. In other words, other polyurethane resin including polyether glycol and polyether triol that has a content greater than a content of the polyether glycol is not suitable to be compared to the polyurethane resin in the present disclosure. In addition, the content of the chain extender is within a specific range so that a weight average molecular weight of the polyurethane resin can be increased and the polyurethane resin has a higher strength. More specifically, the polyurethane resin can have a weight average molecular weight between 27,450 and 29,800. In the polyurethane resin, a cross-linking degree of functional group in a main chain structure of the polyurethane resin can be adjusted through the long-chain polyether triol, thereby improving the strength and a solvent resistance of the polyurethane resin.

The polyurethane resin has a hard chain ratio between 27% and 34%, and the hard chain ratio is defined as a ratio of a sum of the content of the isocyanate and the content of the chain extender divided by the total weight of the polyurethane resin. The hard chain ratio of the polyurethane resin is controlled within a specific range so that the polyurethane resin can have a higher glass transition temperature. Accordingly, the strength of the polyurethane resin can be improved and the polyurethane resin can have an excellent low-temperature bending resistance.

The polyurethane resin has a glass transition temperature between −40.2° C. and −44.8° C., a tensile strength between 62.5 kg/3 cm and 68.7 kg/3 cm, and a viscosity between 34,650 cps and 37,400 cps.

### Polyurethane Resin

The embodiment of the present disclosure further provides a polyurethane resin. The polyurethane resin is made by the aforementioned method for producing a polyurethane resin, but the present disclosure is not limited thereto.

The polyurethane resin includes a polyether glycol, a polyether triol, an isocyanate, a chain extender, a blocking agent, and a diluting solvent. Based on a total weight of the polyurethane resin being 100 wt %, a content of the polyether glycol is between 31.6 wt % and 40.3 wt %, a content of the polyether triol is between 14.5 wt % and 26.3 wt %, a content of the isocyanate is between 18.3 wt % and 21.8 wt %, a content of the chain extender is between 4.5 wt % and 6 wt %, a content of the blocking agent is between 7.8 wt % and 9.9 wt %, and a content of the diluting solvent is between 7.9 wt % and 8.1 wt %.

The polyether glycol has a number average molecular weight between 2,000 and 3,000, and the polyether triol has a number average molecular weight between 3,000 and 6,000. In one of the embodiments, the polyether glycol is polypropylene glycol, the polyether triol is selected from the group consisting of poly-tetramethylene-ether-glycol and polyglycerol, and the isocyanate is selected from the group consisting of methylenediphenyl diisocyanate, toluene diisocyanate, and isophorone diisocyanate.

In one of the embodiments, the chain extender is selected from the group consisting of ethylene glycol, 1,4-butanediol, and 1,6-hexanediol, and the blocking agent is selected from the group consisting of methyl ethyl ketoxime and dimethyl-ketoxime.

In one of the embodiments, the diluting solvent is selected from the group consisting of propylene glycol monomethyl ether acetate and propylene glycol methyl ether. A solid content of the polyurethane resin is between 91% and 92%, and the solid content is defined as a weight ratio of the polyurethane resin after drying to the polyurethane resin before drying.

The polyurethane resin has a hard chain ratio between 27% and 34%, and the hard chain ratio is defined as a ratio of a sum of the content of the isocyanate and the content of the chain extender divided by the total weight of the polyurethane resin.

The polyurethane resin has a glass transition temperature between −40.2° C. and −44.8° C. and a tensile strength between 62.5 kg/3 cm and 68.7 kg/3 cm.

### Experimental Data Test

Hereinafter, a more detailed description will be provided with reference to Exemplary Examples 1 to 4 and Comparative Examples 1 to 3. However, the aforementioned details are disclosed for exemplary purposes only, and are not meant to limit the scope of the present disclosure.

In Exemplary Example 1, the polyurethane resin includes 31.6 wt % of the polyether glycol, 26.3 wt % of the polyether triol, 20 wt % of the isocyanate, 5.3 wt % of the chain extender, 8.7 wt % of the blocking agent, and 8 wt % of the diluting solvent.

In Exemplary Example 2, the polyurethane resin includes 34.3 wt % of the polyether glycol, 21.6 wt % of the polyether triol, 21.2 wt % of the isocyanate, 6 wt % of the chain extender, 8.9 wt % of the blocking agent, and 8 wt % of the diluting solvent.

In Exemplary Example 3, the polyurethane resin includes 37.9 wt % of the polyether glycol, 23.5 wt % of the polyether triol, 18.3 wt % of the isocyanate, 4.5 wt % of the chain extender, 7.8 wt % of the blocking agent, and 8 wt % of the diluting solvent.

In Exemplary Example 4, the polyurethane resin includes 40.3 wt % of the polyether glycol, 14.5 wt % of the polyether triol, 21.8 wt % of the isocyanate, 5.6 wt % of the chain extender, 9.9 wt % of the blocking agent, and 7.9 wt % of the diluting solvent.

In Comparative Example 1, the polyurethane resin includes 24.6 wt % of the polyether glycol, 48.9 wt % of the polyether triol, 11.7 wt % of the isocyanate, 1.7 wt % of the chain extender, 5.2 wt % of the blocking agent, and 7.9 wt % of the diluting solvent.

In Comparative Example 2, the polyurethane resin includes 22.6 wt % of the polyether glycol, 44.9 wt % of the polyether triol, 14.8 wt % of the isocyanate, 3.1 wt % of the chain extender, 6.7 wt % of the blocking agent, and 7.9 wt % of the diluting solvent.

In Comparative Example 3, the polyurethane resin includes 26.8 wt % of the polyether glycol, 38.4 wt % of the polyether triol, 16.3 wt % of the isocyanate, 3.6 wt % of the chain extender, 7.3 wt % of the blocking agent, and 7.6 wt % of the diluting solvent.

For the polyurethane resins of each of the Exemplary Examples 1 to 4 and Comparative Examples 1 to 3, components, glass transition temperature, tensile strength, low-temperature bending resistance, solvent resistance, viscosity, solid content, and weight average molecular weight of the polyurethane resins are listed in Table 1 below, and the relevant test methods are described as follows.

A glass transition temperature test is carried out by placing 5 mg of a sample on a differential scanning calorimeters (Model: TA DSC25) with a temperature rise of 20° C./min from −90° C. to 150° C. for analysis.

A tensile strength test is carried out by using a universal testing machine (Brand: SHIMADZU, Model: AG-X).

Low-temperature bending resistance test is carried out by mounting the sample (4.5 cm*7 cm) on a bending resistance testing machine (Model: GT-7006-V50) with an angle of 22.5°, a frequency of 100 times/minute, and a temperature of −30° C., performing a bending resistance test for 30,000 bending resistance tests, and observing whether the surface of the sample is damaged (e.g., has wrinkles and cracks). A record for being undamaged is indicated by an ‘O’, while a record for being damaged is indicated by an ‘X’.

A solvent resistance test is carried out by completely soaking the sample (5 cm*8 cm) in dimethylformamide (DMF) for 3 minutes, and observing whether the surface of the sample dissolves or not, where ‘O’ represents no dissolution, and ‘X’ represents dissolution.

A viscosity test is carried out by using a viscometer (Brand: BROOKFIELD, Model: DV-E).

A solid content test is carried out as follows. 2 mg of the sample is placed in a pre-weighed container, and the pre-weighed container is placed into an oven (Brand: CHENG-HUI, Model: STD-45B) with a temperature of 110° C. The sample is dried for 3 hours to form a solid sample. The solid sample is weighed, and a solid content is calculated. The solid content (wt %)=(weight of the solid sample/weight of the sample)×100.

A weight average molecular weight test is carried out by using a gel permeation chromatography (Brand: SHIMADZU, Model: LC-40XR).

TABLE 1
[Components of Exemplary Examples and Comparative
Examples and Test Results of Their Physical and Chemical Properties]

| | | Exem- | Exem- | Exem- | Exem- | Com- | Com- | Com- |
|---|---|---|---|---|---|---|---|---|
| | | plary | plary | plary | plary | parative | parative | parative |
| | | Exam- | Exam- | Exam- | Exam- | Exam- | Exam- | Exam- |
| Item | | ple 1 | ple 2 | ple 3 | ple 4 | ple 1 | ple 2 | ple 3 |
| Parameter | content of the polyether | 31.6 | 34.3 | 37.9 | 40.3 | 24.6 | 22.6 | 26.8 |
| of | glycol (wt %) | | | | | | | |
| each | content of the polyether | 26.3 | 21.6 | 23.5 | 14.5 | 48.9 | 44.9 | 38.4 |
| components | triol (wt %) | | | | | | | |
| | content of the isocyanate | 20 | 21.2 | 18.3 | 21.8 | 11.7 | 14.8 | 16.3 |
| | (wt %) | | | | | | | |
| | content of the chain | 5.3 | 6.0 | 4.5 | 5.6 | 1.7 | 3.1 | 3.6 |
| | extender (wt %) | | | | | | | |
| | content of the blocking | 8.7 | 8.9 | 7.8 | 9.9 | 5.2 | 6.7 | 7.3 |
| | agent (wt %) | | | | | | | |
| | content of the diluting | 8.1 | 8.0 | 8.0 | 7.9 | 7.9 | 7.9 | 7.6 |
| | solvent (wt %) | | | | | | | |
| s | glass transition | −44.8 | −42.8 | −43.2 | −40.2 | −55.6 | −53.2 | −47.3 |
| | temperature of the | | | | | | | |
| | polyurethane resin Tg | | | | | | | |
| | (° C.) | | | | | | | |
| | tensile strength of the | 62.5 | 66.3 | 65.6 | 68.7 | 48.6 | 52.7 | 56.8 |
| | polyurethane resin | | | | | | | |
| | (kg/3 cm) | | | | | | | |
| | Low-temperature | ◯ | ◯ | ◯ | ◯ | ◯ | ◯ | ◯ |
| | bending resistance of the | | | | | | | |
| | polyurethane resin | | | | | | | |
| | solvent resistance of the | ◯ | ◯ | ◯ | ◯ | ◯ | ◯ | ◯ |
| | polyurethane resin | | | | | | | |
| | viscosity of the | 35,760 | 38,420 | 34,650 | 37,400 | 21,800 | 26,878 | 30,100 |
| | polyurethane resin (cps) | | | | | | | |
| | solid content of the | 91.8 | 91.7 | 91.7 | 91.6 | 91.5 | 91.7 | 91.6 |
| | polyurethane resin (%) | | | | | | | |
| | weight average molecular | 27,450 | 29,800 | 26,760 | 28,100 | 21,000 | 23,143 | 25,742 |
| | weight of the | | | | | | | |
| | polyurethane resin | | | | | | | |

### Discussion of Test Results

In the Exemplary Examples 1 to 4, since the content of the polyether glycol is between 31.6 wt % and 40.3 wt %, the content of the polyether triol is between 14.5 wt % and 26.3 wt %, and the content of the isocyanate is between 18.3 wt % and 21.8 wt %, the polyurethane resin can meet the requirements of the viscosity between 20,000 cps and 40,000 cps and the tensile strength is greater than 60 kg/3 cm.

The polyurethane resin in the Comparative Examples 1 to 3, since the content of the polyether glycol is relatively low, the content of the polyether triol is relatively high, and the content of the isocyanate is relatively low, the viscosity of the polyurethane resin is relatively high and the tensile strength is relatively low.

### Beneficial Effects of the Embodiments

In conclusion, the method for producing a polyurethane resin provided by the present disclosure, by virtue of “based on a total weight of the polyurethane resin being 100 wt %, a content of the polyether glycol being between 31.6 wt % and 40.3 wt %, a content of the polyether triol being between 14.5 wt % and 26.3 wt %, and a content of the isocyanate being between 18.3 wt % and 21.8 wt %” and “the polyurethane resin having a hard chain ratio between 27% and 34%, a glass transition temperature between −40.2° C. and −44.8° C., and a tensile strength between 62.5 kg/3 cm and 68.7 kg/3 cm,” the issue of existing polyurethane resin used in shoe leather having insufficient strength can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a polyurethane resin, comprising:
a mixing process implemented by mixing a polyether glycol and a polyether triol, wherein the polyether glycol has a number average molecular weight between 2,000 and 3,000, and the polyether triol has a number average molecular weight between 3,000 and 6,000;
a reacting process implemented by adding an isocyanate into the polyether glycol and the polyether triol that are mixed with each other to form a first polymer;
a chain extending process implemented by adding a chain extender to the first polymer to form a second polymer;
a blocking process implemented by adding a blocking agent to the second polymer to form a third polymer; and
a diluting process implemented by diluting the third polymer with a diluting solvent to form a polyurethane resin;
wherein, based on a total weight of the polyurethane resin being 100 wt %, a content of the polyether glycol is between 31.6 wt % and 40.3 wt %, a content of the polyether triol is between 14.5 wt % and 26.3 wt %, and a content of the isocyanate is between 18.3 wt % and 21.8 wt %,
wherein the polyurethane resin has a hard chain ratio between 27% and 34%, and the hard chain ratio is defined as a ratio of a sum of the content of the isocyanate and the content of the chain extender divided by the total weight of the polyurethane resin,
wherein the polyurethane resin has a glass transition temperature between −40.2° C. and −44.8° C. and a tensile strength between 62.5 kg/3 cm and 68.7 kg/3 cm.

2. The method according to claim 1, wherein the polyurethane resin has a weight average molecular weight between 27,450 and 29,800.

3. The method according to claim 1, wherein the polyether glycol is polypropylene glycol, and the polyether triol is selected from the group consisting of poly-tetramethylene-ether-glycol and polyglycerol, and wherein the isocyanate is selected from the group consisting of methylenediphenyl diisocyanate, toluene diisocyanate, and isophorone diisocyanate.

4. The method according to claim 1, wherein the chain extender is selected from the group consisting of an ethylene glycol, 1,4-butanediol, and 1,6-hexanediol, and the blocking agent is selected from the group consisting of methyl ethyl ketoxime and dimethyl-ketoxime.

5. The method according to claim 1, wherein the diluting solvent is selected from the group consisting of propylene glycol monomethyl ether acetate and propylene glycol methyl ether, and wherein the polyurethane resin has a solid content between 91% and 92%, and the solid content is defined as a weight ratio of a weight of the polyurethane resin after drying divided by a weight of the polyurethane resin before drying.

6. The method according to claim 1, wherein, based on the total weight of the polyurethane resin being 100 wt %, a content of the chain extender is between 4.5 wt % and 6 wt %, a content of the blocking agent is between 7.8 wt % and 9.9 wt %, and a content of the diluting solvent is between 7.9 wt % and 8.1 wt %.

7. A polyurethane resin, comprising:
a polyether glycol, wherein the polyether glycol has a number average molecular weight between 2,000 and 3,000;
a polyether triol, wherein the polyether triol has a number average molecular weight between 3,000 and 6,000;
an isocyanate;
a chain extender;
a blocking agent; and
a diluting solvent;
wherein, based on a total weight of the polyurethane resin being 100 wt %, a content of the polyether glycol is between 31.6 wt % and 40.3 wt %, a content of the polyether triol is between 14.5 wt % and 26.3 wt %, and a content of the isocyanate is between 18.3 wt % and 21.8 wt %,
wherein the polyurethane resin has a hard chain ratio between 27% and 34%, and the hard chain ratio is defined as a ratio of a sum of a content of the isocyanate and a content of the chain extender to an overall content of the polyurethane resin,
wherein the polyurethane resin has a glass transition temperature between −40.2° C. and −44.8° C. and a tensile strength between 62.5 kg/3 cm and 68.7 kg/3 cm.

8. The polyurethane resin according to claim 7, wherein the polyurethane resin has a weight average molecular weight between 27,450 and 29,800.

9. The polyurethane resin according to claim 7, wherein the polyether glycol is polypropylene glycol, and the polyether triol is selected from the group consisting of poly-tetramethylene-ether-glycol and polyglycerol, and wherein the isocyanate is selected from the group consisting of methylenediphenyl diisocyanate, toluene diisocyanate, and isophorone diisocyanate.

10. The polyurethane resin according to claim 7, wherein the chain extender is selected from the group consisting of ethylene glycol, 1,4-butanediol, and 1,6-hexanediol, and the blocking agent is selected from the group consisting of methyl ethyl ketoxime and dimethyl-ketoxime.

11. The polyurethane resin according to claim 7, wherein the diluting solvent is selected from the group consisting of propylene glycol monomethyl ether acetate and propylene glycol methyl ether, and wherein a solid content of the polyurethane resin is between 91% and 92%, and the solid content is defined as a weight ratio of the polyurethane resin after drying to the polyurethane resin before drying.

12. The polyurethane resin according to claim 8, based on the total weight of the polyurethane resin being 100 wt %, a content of the chain extender is between 4.5 wt % and 6 wt %, a content of the blocking agent is between 7.8 wt % and 9.9 wt %, and a content of the diluting solvent is between 7.9 wt % and 8.1 wt %.
